(19) United States
(12) Patent Application Publication
(10) Pub. No.: US 2007/0192196 A1
(43) Pub. Date: Aug. 16, 2007

(54) ORDER TAKING SYSTEM FOR A QUICK SERVICE RESTAURANT USING MULTIPLE WIRELESS COMMUNICATION CHANNELS

(75) Inventor: Steven T. Awiszus, Woodbury, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/276,044

(22) Filed: Feb. 10, 2006

(51) Int. Cl. G06Q 30/00; G06Q 50/00

(52) U.S. Cl. 705/15

(57) ABSTRACT

Order taking system for a quick service restaurant enabling a customer to place an order for an item from a drive-through lane, the quick service restaurant having a plurality of staff persons for completing the order. A drive-through order point is positioned in the proximity of the drive-through lane. A plurality of wearable headsets are adapted to be used by the plurality of staff persons. A first wireless voice communication link exists between the drive-through order point and a base station. A second wireless voice communication link exists between the base station and the plurality of headsets. At least one of the plurality of staff persons is able to communicate by voice with the customer at the drive-through lane using the first wireless voice communication link and the second wireless voice communication link. A third wireless voice communication link may exist between the drive-through order point and at least one of the plurality of headsets allowing the drive-through order point to function as a repeater in voice communications between the base station and at least one of the plurality of staff persons. A fourth wireless voice communication link may exist between one the plurality of headsets and another of the plurality of headsets allowing the first of the plurality of headsets to function as a repeater in voice communications between the base station and at least one of the plurality of staff persons.

### RELATED APPLICATION

This disclosure is related to the following co-pending application entitled “System and Method Providing Backup Local Ordering For Establishment Using a Remote Ordering System” by Awiszus (Docket No. 59861US002) (Application No. 10/910,033); filed Aug. 3, 2004), which is not admitted as prior art with respect to the present disclosure by its mention in this section.

### FIELD OF THE INVENTION

The present invention is generally related to order taking systems and, more particularly, to order taking systems using wireless intercom systems for commercial establishments.

### BACKGROUND OF THE INVENTION

It is common for establishments, such as retail establishments, and particularly restaurants, to facilitate drive-up customers with drive-up lanes and windows to service the customer. A customer will typically drive up to a menu/order board and communicate the customer's wishes from the vehicle to staff, possibly including an order taker, inside the retail establishment. The customer, still in the vehicle, will then proceed to one or more windows in order to pay for the purchase, if required, and pick up the merchandise.

An intercom system can facilitate communication within and around the establishment, particularly between the occupant of the vehicle, the customer, and the staff inside the establishment. In a “quick service” restaurant situation, a post mounted speaker and microphone, located near a menu board, is hard wired to an intercom base station located inside the restaurant. The base station can wirelessly communicate with a portable device worn by an order taker. The portable device is typically a transceiver worn as a belt pack and an accompanied wired headset. Alternatively, in some instances, the portable device is self-contained on a wearable headset eliminating the need for a belt pack. The order taker typically listens continually to the post mounted microphone and presses a button in order to speak to the vehicle occupant as needed.

In many systems and methods of ordering items from an establishment from a drive-up or drive-thru facility, the order is orally communicated directly from the post-mounted speaker and microphone to an order taking facility, typically a drive-thru order specialist wearing a headset, in the establishment. The order specialist, or others, then collect the ordered item or items and handle the transaction with the customer at a drive-up window, taking money for the ordered item, making change and handing the order to the customer.

The drive-through ordering system is vitally important for a quick service restaurant. In some quick service restaurants, the drive-through is sixty percent (60%) or more of the revenue of the establishment. Thus, there is a great need for a reliable intercom system for use, for example, in obtaining orders from the drive-through facility. If the intercom system develops a fault, the establishment may be unable to process orders from the drive-through facility not only preventing the establishment from booking the revenue which otherwise would have been obtained but also potentially alienating customers.

A vital link in the drive-through ordering communication system of a quick service restaurant is the communication cable that runs from the drive-through ordering post into the quick service restaurant. This cable may be exposed to the weather and may be subjected to repeated freeze and thaw cycles. Such cables may fail without warning rendering the vital drive-through ordering business for the quick service restaurant inoperable. Furthermore, repairing the communication link involves replacing the cable which may mean digging and tearing up finished paving around the restaurant and/or finished landscaping and other ornamental and functional elements. Replacing the underground cable not only extends the period of time that the drive-through is inoperative but also creates an unpleasant “construction” look to the restaurant which may drive away customers.

### BRIEF SUMMARY OF THE INVENTION

Intercom systems of a typical quick service restaurant may already use wireless communication technology to communicate between a base station located inside the restaurant with one or more wearable headsets worn by restaurant personnel involved in the ordering process, order preparation or order delivery process. Such wireless communication links allow restaurant personnel to move freely about the restaurant and perform their job functions without being tied to a particular location.

An embodiment of the present invention utilizes a second wireless communication channel (or an additional wireless communication channel if more than one channel is already used in headset communication) to facilitate the communication link between the drive-through ordering point and the base station of the intercom system. Such wireless communication eliminates the need for underground communication cable between the drive-through ordering point and the base station and, more importantly, eliminates the underground cable as a failure point and further eliminates the necessity of tearing up the grounds of the restaurant in order to replace the cable. This wireless communication link is established for an entirely different purpose than the wireless communication link between the base station and one or more headsets since mobility is the primary reason to use wireless communication for headset communication. Both the drive-through ordering point and the base station may be stationary and, yet, it is still advantageous to use wireless communication for this communication link.

Furthermore, restaurant personnel are often involved in outside job functions, such as grounds maintenance, removing trash and/or litter and possibly delivering orders to customers. The wireless communication link to the headsets worn by restaurant personnel depend on an adequate signal from the base station of the intercom system.

Since the base station is located in the interior of the restaurant, personnel operating outside of the restaurant must be able to pick up the wireless signal from the base station through the restaurant walls and, potentially, additional interior partitions. Thus, an embodiment of the invention uses the drive-through ordering point and a third (or additional) wireless communication link so that the drive-through ordering point may be used as a repeater to relay communication otherwise appearing on the interior wireless link to an outside wireless communication link. Further, one or more headsets being worn outside by restaurant personnel may also be utilized as a repeater on an additional wireless channel, instead of or in addition to the use of the drive-through ordering point as a repeater.

In an embodiment, the present invention provides an order taking system for a quick service restaurant enabling a customer to place an order for an item from a drive-through lane, the quick service restaurant having a plurality of staff persons for completing the order. A drive-through order point is located near the drive-through lane, the drive-through order point being capable of receiving the order for the item from the customer. A plurality of wearable headsets are adapted to be used by the plurality of staff persons. A first wireless voice communication link exists between the order placing equipment and a base station. A second wireless voice communication link exists between the base station and the plurality of headsets. At least one of the plurality of staff persons is able to communicate by voice with the customer at the drive-through lane using the first wireless voice communication link and the second wireless voice communication link.

In an embodiment, the present invention provides an order taking system for a quick service restaurant enabling a customer to place an order for an item from a drive-through lane, the quick service restaurant having a plurality of staff persons for completing the order. A drive-through order point is positioned in the proximity of the drive-through lane. A plurality of wearable headsets are adapted to be used by the plurality of staff persons. A first wireless voice communication link exists between the drive-through order point and a base station. A second wireless voice communication link exists between the base station and the plurality of headsets. At least one of the plurality of staff persons is able to communicate by voice with the customer at the drive-through lane using the first wireless voice communication link and the second wireless voice communication link. A third wireless voice communication link exists between the drive-through order point and at least one of the plurality of headsets allowing the drive-through order point to function as a repeater in voice communications between the base station and at least one of the plurality of staff persons.

In an embodiment, a fourth wireless voice communication link between at least one of the plurality of headsets and another one of the plurality of headsets allowing the at least one of the plurality of headsets to function as a repeater in voice communications between the at least one of the plurality of headsets and another of the plurality of headsets.

In an embodiment, the present invention provides a method of taking orders associated with a quick service restaurant enabling a customer to place an order for an item from a drive-through lane, the quick service restaurant having a plurality of staff persons for completing the order. A base station receives the order for the item from the customer from a drive-through order point on a first wireless voice communication link. The base station communicates with at least one of a plurality of wearable headsets adapted to be used by the plurality of staff persons on a second wireless communication link. Whereby at least one of the plurality of staff persons are able to communicate by voice with the customer at the drive-through lane using the first wireless voice communication link and the second wireless voice communication link.

In an embodiment, the present invention provides a method of taking orders associated with a quick service restaurant enabling a customer to place an order for an item from a drive-through lane, the quick service restaurant having a plurality of staff persons for completing the order. A base station receives the order for the item from the customer from a drive-through order point on a first wireless communication link. The base station communicates with at least one of a plurality of wearable headsets adapted to be used by the plurality of staff persons on a second wireless voice communication link. Whereby at least one of the plurality of staff persons are able to communicate by voice with the customer at the drive-through lane using the first wireless voice communication link and the second wireless voice communication link. The drive-through order point functioning as a repeater in voice communication between the base station and at least one of the plurality of staff persons using a third wireless voice communication link between the drive-through order point and at least one of the plurality of headsets.

In an embodiment, a fourth wireless voice communication link between at least one of the plurality of headsets and another one of the plurality of headsets allows the at least one of the plurality of headsets to function as a repeater in voice communications between the at least one of said plurality of headsets and another of the plurality of headsets.

In an embodiment, the first wireless voice communication link is full duplex.

In an embodiment, the second wireless voice communication link is full duplex.

In an embodiment, the third wireless voice communication link is full duplex.

In an embodiment, the first wireless voice communication link and the second wireless voice communication link occur on a plurality of channels.

In an embodiment, the plurality of channels operate on a plurality of frequencies.

In an embodiment, the plurality of channels operate using time division multiple access (TDMA).

In an embodiment, the plurality of channels operate using code division multiple access (CDMA).

### BRIEF DESCRIPTION OF THE DRAWINGS

FIG. 1 is a block diagram of the functional components of an ordering system;

FIG. 2 is block diagram of the functional components of an alternative ordering system; and

FIG. 3 is flow chart illustrating wireless communication in an ordering system and wireless repeating in an ordering system.

### DETAILED DESCRIPTION OF THE INVENTION

The contents of co-pending United States Patent Application entitled “System and Method Providing Backup Local Ordering For Establishment Using a Remote Ordering System” by Awiszus (Docket No. 59861US002) (Application No. 10/910,033); filed Aug. 3, 2004), is hereby incorporated by reference in its entirety.

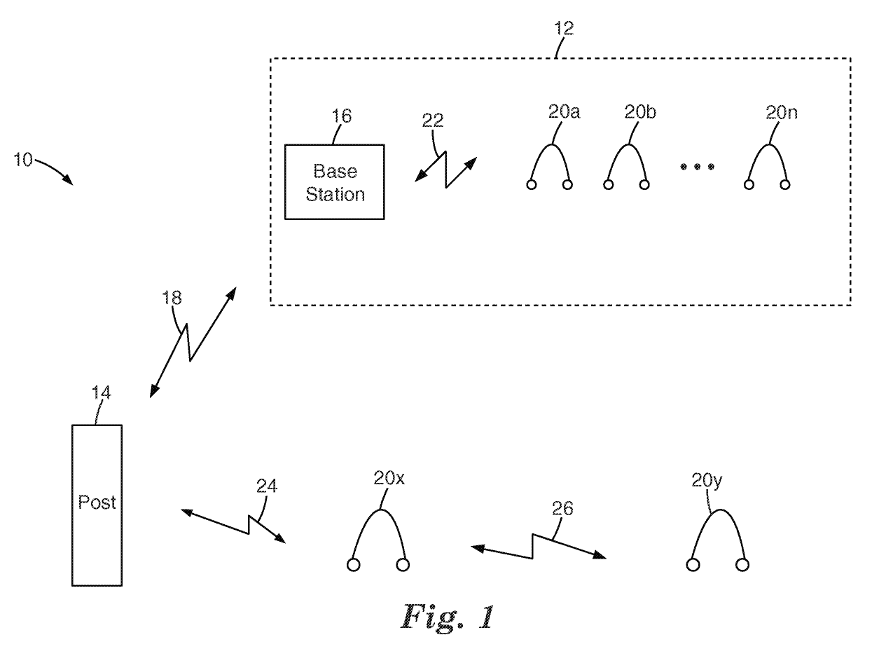

FIG. 1 illustrates a block diagram of an order taking system 10 for a quick service restaurant 12. Drive-through order point 14, typically a communication post associated with or near a menu board, placed near a drive-through ordering lane which customers may approach in their vehicles and verbally order directly from their vehicle using communication equipment located in or associated with the communication post. Such drive-through order point 14 is coupled in verbal communication with base station 16 located in establishment 12 using wireless communication link 18.

Base station 16 communicates wirelessly with a plurality of headsets 20a, 20b, . . . 20n on wireless communication link 22. Headsets 20a, 20b, . . . 20n are worn by personnel, or staff of establishment 12, one or more of whom may either communicate with a customer communicating through drive-through order point 14 or monitor oral communication with drive-through order point 14. At least one of the staff members may communicate with a customer in the drive-through facility using drive-through order point 14 to obtain an order from the customer. Staff members may be wearing, and communicating through, one of headsets 20a, 20b, . . . 20n or may be in wired communication with base station 16. Other staff members will wear headsets 20a, 20b, . . . 20n or the remaining ones of headsets 20a, 20b, . . . 20n, primarily to listen, or monitor communication between the customer and staff member taking the order.

Wireless communication link 18 is preferably located on a different channel than wireless communication link 22, thus preventing interference between the wireless signals. It is contemplated that any commonly known and readily available wireless technology may be used for this purpose. Wireless communication may be radio frequency and multiple channels may be obtained by using multiple frequencies, by using time-division multiple access (TDMA), code-division multiple access (CDMA) or other commonly known and available technologies.

It is to be recognized and understood that more than one drive-through order point 14 may be coupled to intercom system 10 using the described technique. Multiple drive-through order points 14 may be advantageous, for example, in quick service restaurants having a plurality of drive-through lanes. In this case, separate drive-through order points 14 and separate wireless communication links 18 may be utilized, typically one for each drive-through lane.

Equipment for wireless communication link 18 may be contained within drive-through order point 14, typically an order post located near the restaurant's drive-through menu board. The wireless module can be supplied with a low voltage power source.

Alternatively, a battery may be used as a power supply, optionally recharged with a solar cell. The wireless module can be positioned within a weather resistant case or enclosure.

The wireless module can interface with a microphone, preferably dynamic or electret types, a power amplifier/speaker driver, typically two watts into eight ohms, and logic or frequency signals from a vehicle presence detector.

The wireless unit is then configured for wireless communication with base station 16 located in quick service restaurant 12. Wireless communication preferably supports both half and full duplex audio paths. While many readily available communication technologies are available, one technology which may be used is one of the digital, frequency hopping, spread spectrum type. Examples of this technology include IEEE standard 802.11x, WDECT and Bluetooth.

Radio frequency signal from drive-through order point 14 can be wirelessly locked to base station 16 through encryption or other type of encoding. This secure radio frequency communication link 18 should be relatively immune to unauthorized access and interference from noise sources. Such technology is readily available and currently practiced in wireless communication arts.

Quick service restaurant 12 personnel may be involved in job functions exterior to the restaurant structure such as performing maintenance or in delivering an order to a customer. Such personnel may receive diminished wireless communication ability due to a decrease in signal strength from base station 16 since the wireless signal typically must pass through building materials to reach the exterior location. An example shown in FIG. 1 is headset 20x. In an embodiment, drive-through order point 14 contains additional electronics to support an additional wireless communication channel to provide wireless communication 24 between drive-through order point 14 and headset 20x.

Wireless communication link 24 may be configured to repeat any conversation occurring on wireless communication link 18 to headset 20x. Drive-through order point 14 is a better communication point for headset 20x since drive-through order point 14 is already located outside of restaurant 12 and the wireless signal available to headset 20x from drive-through order point 14 is typically greater than the wireless signal available from base station 16. Thus, drive-through order point 14 can operate as a repeater to relay ordering communication occurring on communication link 18 to headset 20x.

Further, headset 20x may be configured to serve as a relay or repeater on still another wireless communication link 26 to another headset 20y also located exterior to quick service restaurant 12, typically at a greater distance from drive-through order point 14.

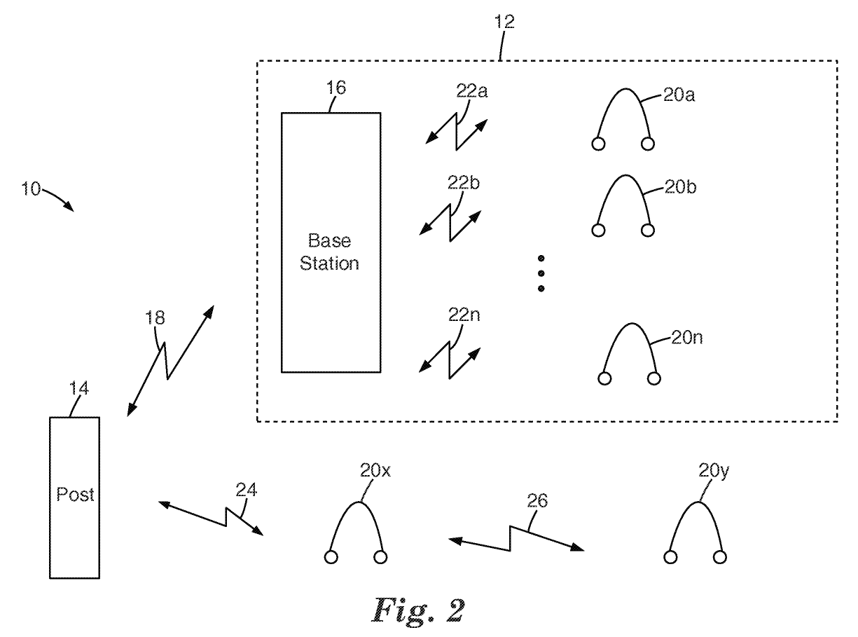

FIG. 2 illustrates a block of an order taking system 10 for a quick service restaurant 12 similar to that described with respect to FIG. 1. In FIG. 2, however, headsets 20a, 20b, . . . 20n each individually wirelessly communicate on individual wireless communication links 22a, 22b, . . . 22n instead of over a common wireless communication link 22.

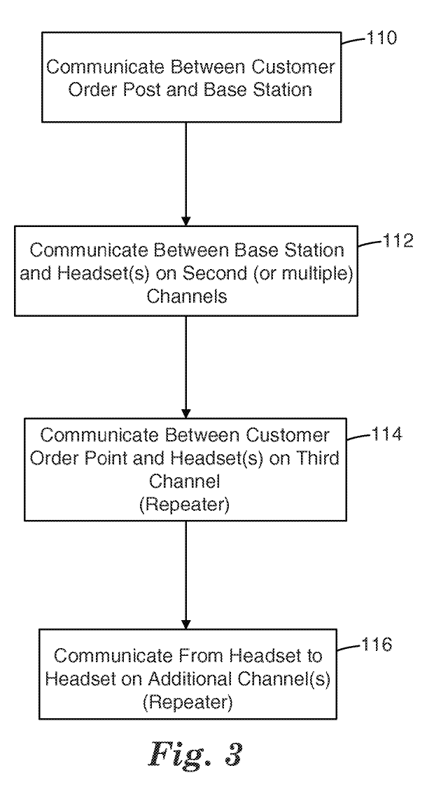

FIG. 3 is a block diagram illustrating a method of taking orders using a intercom system 10 with a wireless communication link 18 between a drive-through order point 14 and a base station 16. An order is communicated (110) between drive-through order point 14, customer order post, and base station 16. The order is then communicated (112) between base station 16 and one or more headsets 20 worn by restaurant 12 personnel on a second channel or on multiple channels (see FIG. 2). Optionally, communication occurs (114) between drive-through order point 14, customer order post, and an additional headset 20x, typically located exterior to restaurant 12, on a third or additional channel. Drive-through order point 14 operates as a repeater to relay communication on communication link 18 to headset 20x. Optionally, communication further occurs (116) between headset 20x and an additional headset 20y, also typically located exterior to restaurant 12 but perhaps more distant, on a fourth or additional channel. Headset 20x operates as a repeater to relay communication on communication link 24 to headset 20y.

Thus, embodiments of the order taking system for a quick service restaurant using multiple wireless communication channels are disclosed. One skilled in the art will appreciate that the present invention can be practiced with embodiments other than those disclosed. The disclosed embodiments are presented for purposes of illustration and not limitation, and the present invention is limited only by the claims that follow.

What is claimed is:

1. An order taking system for a quick service restaurant enabling a customer to place an order for an item from a drive-through lane, said quick service restaurant having a plurality of staff persons for completing said order, comprising:
a drive-through order point located near said drive-through lane, said drive-through order point being capable of receiving said order for said item from said customer;
a base station;
a plurality of wearable headsets adapted to be used by said plurality of staff persons;
a first wireless voice communication link between said order placing equipment and said base station; and
a second wireless voice communication link between said base station and said plurality of headsets;
at least one of said plurality of staff persons being able to communicate by voice with said customer at said drive-through lane using said first wireless voice communication link and said second wireless voice communication link.

2. An order taking system as in claim 1 wherein said first wireless voice communication link is full duplex.

3. An order taking system as in claim 2 wherein said second wireless voice communication link is full duplex.

4. An order taking system as in claim 1 wherein said first wireless voice communication link and said second wireless voice communication link occur on a plurality of channels.

5. An order taking system as in claim 4 wherein said plurality of channels operate on a plurality of frequencies.

6. An order taking system as in claim 4 wherein said plurality of channels operate using time division multiple access (TDMA).

7. An order taking system as in claim 4 wherein said plurality of channels operate using code division multiple access (CDMA).

8. An order taking system for a quick service restaurant enabling a customer to place an order for an item from a drive-through lane, said quick service restaurant having a plurality of staff persons for completing said order, comprising:
a drive-through order point positioned in the proximity of said drive-through lane;
a base station;
a plurality of wearable headsets adapted to be used by said plurality of staff persons;
a first wireless voice communication link between said drive-through order point and said base station; and
a second wireless voice communication link between said base station and said plurality of headsets;
at least one of said plurality of staff persons being able to communicate by voice with said customer at said drive-through lane using said first wireless voice communication link and said second wireless voice communication link; and
a third wireless voice communication link between said drive-through order point and at least one of said plurality of headsets allowing said drive-through order point to function as a repeater in voice communications between said base station and at least one of said plurality of staff persons.

9. An order taking system as in claim 8 wherein said first wireless voice communication link is full duplex.

10. An order taking system as in claim 9 wherein said second wireless voice communication link is full duplex.

11. An order taking system as in claim 10 wherein said third wireless voice communication link is full duplex.

12. An order taking system as in claim 8 wherein said first wireless voice communication link, said second wireless communication link and said third wireless voice communication link occur on a plurality of channels.

13. An order taking system as in claim 12 wherein said plurality of channels operate on a plurality of frequencies.

14. An order taking system as in claim 12 wherein said plurality of channels operate using time division multiple access (TDMA).

15. An order taking system as in claim 12 wherein said plurality of channels operate using code division multiple access (CDMA).

16. An order taking system as in claim 8 further comprising a fourth wireless voice communication link between at least one of said plurality of headsets and another one of said plurality of headsets allowing said at least one of said plurality of headsets to function as a repeater in voice communications between said at least one of said plurality of headsets and another of said plurality of headsets.

17. A method of taking orders associated with a quick service restaurant enabling a customer to place an order for an item from a drive-through lane, said quick service restaurant having a plurality of staff persons for completing said order, comprising:
communicating on a first wireless voice communication link from a drive-through order point capable of receiving said order for said item from said customer to a base station;
communicating on a second wireless voice communication link from said base station to at least one of a plurality of wearable headsets adapted to be used by said plurality of staff persons;
whereby at least one of said plurality of staff persons are able to communicate by voice with said customer at said drive-through lane using said first wireless voice communication link and said second wireless voice communication link.

18. A method as in claim 17 wherein said first wireless voice communication link is full duplex.

19. A method as in claim 18 wherein said second wireless voice communication link is full duplex.

20. A method as in claim 17 wherein said first wireless voice communication link and said second wireless voice communication link occur on a plurality of channels.

21. A method as in claim 20 wherein said plurality of channels operate on a plurality of frequencies.

22. A method as in claim 20 wherein said plurality of channels operate using time division multiple access (TDMA).

23. A method as in claim 20 wherein said plurality of channels operate using code division multiple access (CDMA).

24. A method of taking orders associated with a quick service restaurant enabling a customer to place an order for an item from a drive-through lane, said quick service restaurant having a plurality of staff persons for completing said order, comprising:
communicating on a first wireless voice communication link from a drive-through order point capable of receiving said order for said item from said customer to a base station;
communicating on a second wireless voice communication link from said base station to at least one of a plurality of wearable headsets adapted to be used by said plurality of staff persons;
whereby at least one of said plurality of staff persons are able to communicate by voice with said customer at said drive-through lane using said first wireless voice communication link and said second wireless voice communication link; and
communicating on a third wireless voice communication link between said drive-through order point and at least one of said plurality of headsets allowing said drive-through order point to function as a repeater in voice communications between said base station and at least one of said plurality of staff persons.

25. A method as in claim 24 wherein said first wireless voice communication link is full duplex.

26. A method as in claim 25 wherein said second wireless voice communication link is full duplex.

27. A method as in claim 26 wherein said third wireless voice communication link is full duplex.

28. A method as in claim 24 wherein said first wireless voice communication link, said second wireless communication link and said third wireless voice communication link occur on a plurality of channels.

29. A method as in claim 28 wherein said plurality of channels operate on a plurality of frequencies.

30. A method as in claim 28 wherein said plurality of channels operate using time division multiple access (TDMA).

31. A method as in claim 28 wherein said plurality of channels operate using code division multiple access (CDMA).

32. A method as in claim 24 further comprising the step of communicating on a fourth wireless voice communication link between at least one of said plurality of headsets and another one of said plurality of headsets allowing said at least one of said plurality of headsets to function as a repeater in voice communications between said at least one of said plurality of headsets and another of said plurality of headsets.
